(19) United States
(12) Patent Application Publication
(10) Pub. No.: US 2020/0262641 A1
(43) Pub. Date: Aug. 20, 2020

(54) PROPPANT DELIVERY SYSTEM COMPRISING SILOS AND SMALLER RECTANGULOID STORAGE CONTAINERS CARRIED ON A SUPPORT STAND AND RELATED METHOD

(71) Applicant: Hi-Crush Canada Inc., Houston, TX (US)

(72) Inventor: Henry Friesen, Winkler (CA)

(21) Appl. No.: 16/275,427

(22) Filed: Feb. 14, 2019

(51) Int. Cl. B65D 88/28; E21B 41/00; B65D 88/08; B65D 90/12; B65G 65/40

(52) U.S. Cl. CPC B65D 88/28; E21B 41/00; E21B 43/267; B65D 90/12; B65G 65/40; B65D 88/08

(57) ABSTRACT

A proppant delivery system for use at a hydraulic fracturing site to prepare a proppant mixture for subsequent delivery to a wellbore at the hydraulic fracturing site comprises two types of proppant storage containers, including silo type and box-like container type each of which normally has a dedicated system to dispense proppant, arranged in an array usually employed in a silo-only delivery system where parallel rows are formed and interrupted by a feed conveyor extending parallel to and disposed between the rows. A support stand carries the box-like container to one side of the feed conveyor with a bottom discharge of this container held at a spaced height above a ground surface.

### FIELD OF THE INVENTION

The present invention relates generally to a proppant delivery system for use at a hydraulic fracturing site, and more particularly to such a system employing both relatively small capacity rectanguloid storage containers receiving specialty proppants used in relatively small quantities for forming a proppant mixture at a blender and comparatively larger silos receiving a primary proppant which forms a largest proportion of the proppant mixture.

### BACKGROUND

In the fracking industry, there are predominantly two types of proppant containers which are used at a hydraulic fracturing operation site to temporarily store and subsequently discharge proppant for delivery to a blender at the site in which an appropriate mixture of proppant is prepared for subsequent delivery to a nearby wellbore at the same hydraulic fracturing site. The proppant mixture comprises both a primary type of proppant, which forms a largest portion of the mixture in comparison to other types of proppant, and secondary types of proppant which are used in the mixture in smaller quantities as compared to the primary proppant. A proppant storage container is used at any time to store a single type of proppant; that is, multiple types of proppant are not simultaneously contained within a single container so as to avoid uncontrollable mixing thereof during discharge from the container.

A first type of proppant storage and delivery container is a box-like container which comprises a cubic or rectanguloid container having a top upwardly-opening fill opening and a bottom downwardly-facing discharge so that particulate material stored therein in the form of proppant is discharged from the cubic or rectanguloid container by gravity to a discharge location disposed within a periphery of the container defined by a rectangular peripheral wall of the container. The container is mounted on a frame which forms an annular base so that the box-like container can be rested on a support surface. However, the annular base is located substantially in a common plane with the discharge of the box-like container. The box-like container with its base is typically in the order of about 8.5 feet in height and is in the order of 8 feet in width with a hopper bottom locating the gravity discharge.

Furthermore, the box-like proppant storage container is filled with material at a remote location to the fracking site and is loaded typically onto a flat deck trailer towed by a semi-tractor for transport to the fracking site. Once the containers are emptied, they are transported back to the filling site and replaced by pre-filled containers transported to the hydraulic fracturing site. The box-like container typically is handled on site, whether at the filling site or the fracking site, by a forklift which lifts the box-like container and moves to the desired location within the site.

A box-like container type of proppant storage container is filled via its top fill opening with a conveyor typically of the inclined type which elevates the material from an intake location to a raised discharge location to transfer the material from a transport truck at ground level to the top of the box-like container.

At the fracking site, the box-like container is disposed vertically over a feed conveyor so as to discharge material by gravity vertically downwardly onto the feed conveyor which is operatively communicated with the blender receiving the proppant.

A second type of storage container predominant in the fracking industry is a storage silo which is generally circular cylindrical in shape and is much taller in height than the box-like type of container, typically being in the order of about 40 to 50 feet. Accordingly the silo has a significantly greater capacity for storing proppant than the box-like container.

The silo has a top fill opening which opens upwardly so as to be fillable therethrough but also typically includes a pneumatic filling system comprising a plurality of ducts extending upwardly along a height of the silo at angularly spaced positions about the silo and communicated with an interior of the silo at a plurality of spaced locations across the height of the silo. The pneumatic filling system thus is arranged to pneumatically convey particulate material substantially from ground level upon receipt from a transport truck and upwardly to the silo which has a raised bottom. The silo is supported with its bottom discharge raised above a planar base, with upstanding legs interconnecting the silo and base.

The silo is transported to the fracking site in an emptied state on a trailer towed by a semi-tractor. During transport the silo is supported in a substantially horizontal orientation but upon arrival at or delivery to the fracking site where the silo will be used to temporarily store proppoant, the silo is raised by operation of the specially designed trailer from its horizontal transport condition to an upstanding condition in which the silo is rested on its base with which it was transported.

At the fracking site the silo is arranged as part of an array of silos relative to a feed conveyor. Typically, the array comprises a pair of rows each of adjacent silos that are interrupted by a feed conveyor extending parallel to the rows. That is, the feed conveyor is located intermediate the rows and is oriented so as to convey material in a direction substantially parallel to the rows. The silos once arranged in the array are fillable on site, and thus discharge the material stored therein to the feed conveyor which is arranged to one side of each of the silos in the array. Each silo in a common row of the array discharges material to the feed conveyor in a common direction as the other silos in that row. The feed conveyor then transfers the proppant received from the silos to the blender which is located generally longitudinally in-line with the feed conveyor.

The box-like types of containers are suitably sized in volumetric capacity for storing the secondary types of proppant which are specialty proppants used in forming the proppant mixture delivered to the wellbore. Based on the amount of specialty proppant typically used in a fracking operation, a silo is generally too large for its entire volumetric capacity to be used to store a specialty proppant and thus if a silo were used in this manner, the silo capacity would not be utilized to its maximum capacity.

### SUMMARY OF THE INVENTION

It is an aspect of the invention to provide a proppant delivery system for use at a hydraulic fracturing site to prepare a proppant mixture for subsequent delivery to a wellbore at the hydraulic fracturing site, comprising:

a plurality of a first type of proppant storage container for storing a primary type of proppant for use in forming the proppant mixture;

the first type of proppant storage container comprising:
a silo having a cylindrical peripheral wall encompassing an upstanding axis of the silo;
the silo defining a fill opening for receiving the primary type of proppant in the silo;
the silo having a bottom discharge at a bottom of the silo for releasing the primary type of proppant received in the silo;
the bottom discharge being arranged to convey the primary type of proppant towards one side of the silo so as to be discharged to said one side;
the silo being sized larger in height from the bottom discharge to a top of the silo than in diameter of the cylindrical peripheral wall;
a planar base oriented substantially perpendicularly to the upstanding axis of the container and spaced below the bottom discharge of the silo for resting on a ground surface; and
a plurality of upstanding legs interconnecting the silo and the base;

at least one of a second type of proppant storage container for storing a secondary type of proppant for use in a lesser quantity as compared to the primary type of proppant in forming the proppant mixture;

the second type of proppant storage container comprising:
a rectanguloid container having a rectangular peripheral wall encompassing an upstanding axis of the rectanguloid container;
the rectanguloid container being sized smaller in volume than the silo;
the rectanguloid container defining a top fill opening at a top of the rectanguloid container for receiving the secondary type of proppant therein;
the rectanguloid container having a bottom discharge at a bottom of the rectanguloid container for releasing the second type of proppant received in the rectanguloid container;
a support frame connected to the rectanguloid container and defining an annular base which is adapted for resting on the ground surface;
the annular base encompassing the bottom discharge of the rectanguloid container and being disposed at substantially a common height with a terminus of the bottom discharge from which the second type of proppant is arranged to exit the rectanguloid container;

the second type of proppant storage container being sized shorter in height than the first type of proppant storage container;

the plurality of the first type of proppant storage container and the at least one of the second type of proppant storage container being arranged in an array comprising a pair of substantially parallel rows;

a feed conveyor disposed between the rows of the array and arranged to transfer particulate material in a direction which is substantially parallel to the rows to a discharge of the feed conveyor;

the feed conveyor being operatively coupled to receive the first and second types of proppant stored in the first and second types of proppant storage containers;

a blender operatively coupled to the discharge of the feed conveyor so as to receive the particulate material therefrom for mixing to form the proppant mixture;

the at least one of the second type of proppant storage container that is arranged in the array being located on a support stand, the support stand defining at a top thereof a platform which is connected to the support frame of the at least one of the second type of proppant storage container and further including a plurality of upstanding legs depending downwardly from the platform to bottoms of the legs which are adapted for resting on the ground surface such that the terminus of the bottom discharge of the at least one of the second type of proppant storage container is held at a spaced height above the ground surface so that the second type of proppant can be discharged to the feed conveyor.

This provides an arrangement for dispensing proppant at a hydraulic fracturing site which combines two types of delivery systems each based on a different type of storage container so as to maximize volumetric capacity of each container type.

In the illustrated arrangement, the at least one of the second type of proppant storage container carried on the support stand and arranged in the array is located more closely to the feed conveyor in a transverse direction to the rows than a respective one of the first type of proppant storage container.

In the illustrated arrangement, the terminus of the bottom discharge of the second type of proppant storage container is raised relative to a terminus of the bottom discharge of the first type of proppant storage container from which the primary type of proppant is arranged to exit the first type of proppant storage container for subsequent receipt by the feed conveyor.

Preferably, the support stand further includes a chute mounted in fixed location to the platform for interconnecting the terminus of the bottom discharge of the at least one of the second type of proppant storage container and an intake of the feed conveyor.

According to another aspect of the invention there is provided a support stand for a storage container which is used to store a hydraulic fracturing proppant, the storage container having:

a rectanguloid container having a rectangular peripheral wall encompassing an upstanding axis of the rectanguloid container;

the rectanguloid container defining a top fill opening at a top of the rectanguloid container for receiving the proppant therein;

the rectanguloid container having a bottom discharge at a bottom of the rectanguloid container for releasing the proppant received in the rectanguloid container;

the bottom discharge defining a downwardly opening aperture such that the proppant is released in a downward direction therefrom;

a support frame connected to the rectanguloid container and defining an annular base which is adapted for resting on a ground surface;

the annular base encompassing the bottom discharge of the rectanguloid container and being disposed at substantially a common height with a terminus of the bottom discharge from which the second type of proppant is arranged to exit the rectanguloid container;

the support stand comprising:

a plurality of upstanding legs having bottoms which are adapted for resting on the ground surface;

a platform connected to the legs at a spaced height above the bottoms of the legs;

the platform defining a substantially horizontal support surface for carrying the support frame of the storage container such that the bottom discharge of the storage container is held at a spaced height above the ground surface; and

a chute mounted in fixed location to the platform having an intake which is communicable with the terminus of the bottom discharge of the storage container, the chute extending downwardly and horizontally from the intake to a discharge of the chute so as to guide the proppant towards a side of the support stand.

According to yet another aspect of the invention there is provided a method of dispensing proppant at a hydraulic fracturing site to prepare a proppant mixture for subsequent delivery to a wellbore at the hydraulic fracturing site, comprising:

providing a storage container storing a proppant for use in forming the proppant mixture, the storage container comprising:
a rectanguloid container having a rectangular peripheral wall encompassing an upstanding axis of the rectanguloid container;
the rectanguloid container defining a top fill opening at a top of the rectanguloid container for receiving the proppant therein;
the rectanguloid container having a bottom discharge at a bottom of the rectanguloid container for releasing the proppant received in the rectanguloid container;
a support frame connected to the rectanguloid container and defining an annular base which is adapted for resting on a ground surface;
the annular base encompassing the bottom discharge of the rectanguloid container and being disposed at substantially a common height with a terminus of the bottom discharge from which the second type of proppant is arranged to exit the rectanguloid container;

providing a feed conveyor operable to receive the proppant from the storage container and to transfer the proppant in a longitudinal direction along the feed conveyor;

providing a blender operable to receive the proppant from the feed conveyor and to mix the proppant for forming the proppant mixture;

supporting the storage container to one side of the feed conveyor at a spaced height above the ground surface so that the bottom discharge thereof is transversely spaced from the feed conveyor and is spaced above the ground surface; and

transferring the proppant from the storage container to the feed conveyor for subsequent delivery to the blender.

Preferably, supporting the storage container comprises:

providing a support stand which is distinct from the storage container for supporting the storage container at the spaced height above the ground surface;

locating the support stand to said one side of the feed conveyor; and

locating the storage container on the support stand.

Preferably, the intake of the chute is raised above a substantially horizontal support surface defined by the platform for engaging a bottom of the annular base of the at least one of the second type of proppant storage container.

Preferably, the chute is inclined downwardly and horizontally from the intake of the chute, which is communicated with the terminus of the bottom discharge of the at least one of the second type of proppant storage container, to the discharge of the chute at an angle between 30 and 40 degrees below a horizontal plane.

Preferably, the at least one of the second type of proppant storage container includes an annular member attached to the bottom discharge and depending downwardly beyond the terminus of the bottom discharge for substantially sealing with the intake of the chute which is in communication with the terminus of the bottom discharge.

Preferably, the intake of the chute is oversized relative to the terminus of the bottom discharge so as to receive substantially therein an annular inner portion of the annular member which defines a downward extension of the terminus of the bottom discharge.

Preferably, the annular member includes an annular outer portion extending downwardly from the bottom discharge at an outwardly spaced location from the terminus thereof so as to surround a periphery of the intake of the chute for resisting entrance of moisture at the intake of the chute.

In one arrangement, the annular inner portion is disposed in substantially sealing contact within the intake of the chute and the annular outer portion is disposed at an external spaced location relative to the intake of the chute so as not to be in contact therewith.

In one arrangement, the annular outer portion is inclined downwardly and radially outwardly from the terminus of the bottom discharge so as to deflect precipitation away from the intake of the chute. In one arrangement, the chute is supported by a pair of spaced substantially parallel and substantially horizontally extending beams connected to the platform such that the chute is disposed between the beams, the beams being generally tubular in shape and open at one or more ends thereof so as to be suited for receiving forks of a forklift for moving the support stand at the hydraulic fracturing site.

Preferably, the chute extends from the intake of the chute to the discharge thereof substantially parallel to the beams.

Preferably, the discharge of the chute is suspended from the platform so that an area between the legs of the stand is substantially unobstructed

Preferably, the support stand includes a plurality of upstanding guide pins projecting upwardly above the platform and located thereon at spaced locations for mating with the support frame of the at least one of the second type of proppant storage container so as to align the bottom discharge thereof relative to the support stand.

### BRIEF DESCRIPTION OF THE DRAWINGS

The invention will now be described in conjunction with the accompanying drawings in which:

FIG. 1 is a perspective view of an arrangement of proppant delivery system according to the present invention, with one proppant storage silo omitted for clarity of illustration;

FIG. 2 is an end view of the arrangement as shown in FIG. 1;

FIG. 3 is a side view of the arrangement of FIG. 1;

FIG. 4 is a top plan view of the arrangement of FIG. 1;

FIG. 5 is a cross-sectional view along line 5-5 in FIG. 4;

FIG. 6 is a perspective view of an arrangement of support stand according to the present invention;

FIG. 7 is a cross-sectional view of the support stand arrangement of FIG. 6 as if it were taken along line 7-7 in FIG. 6 but with a storage container mounted thereon; and

FIG. 8 is a cross-sectional view along line 8-8 in FIG. 7.

In the drawings, like characters of reference indicate corresponding parts in the different figures.

### DETAILED DESCRIPTION

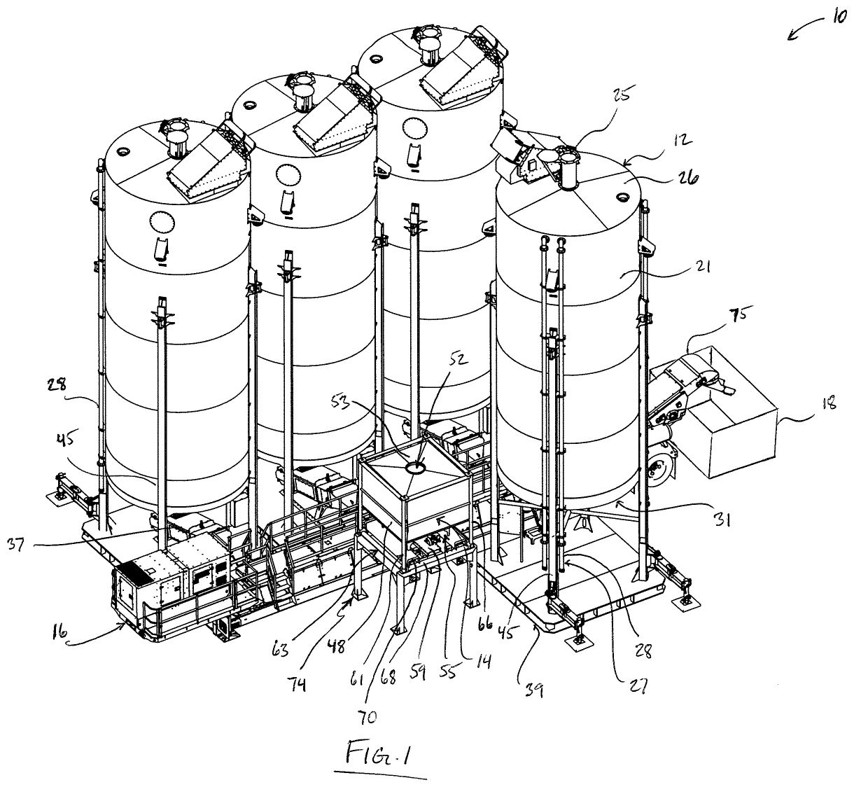

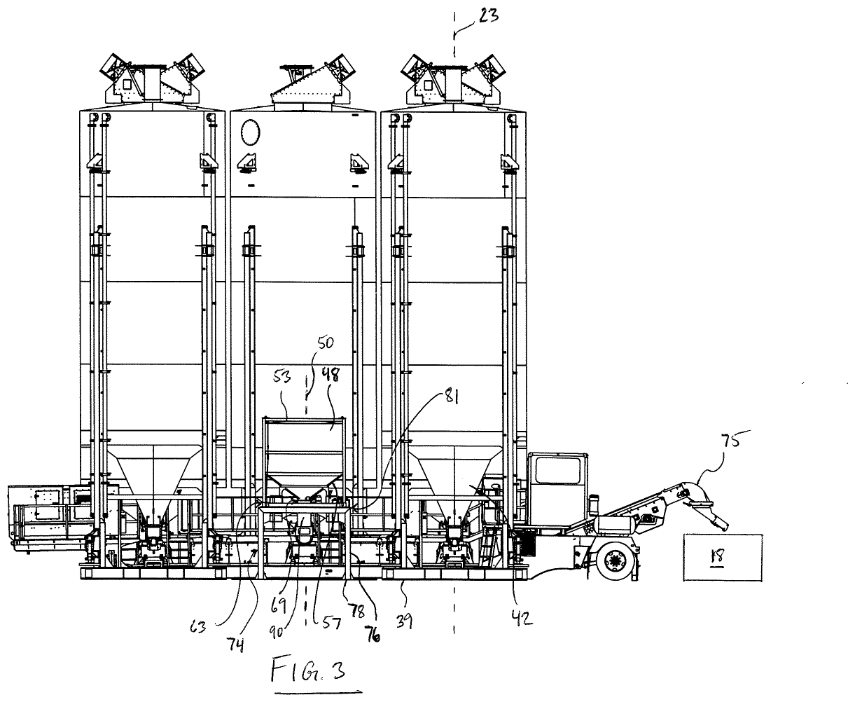

FIGS. 1-5 show a proppant delivery system 10 for use at a hydraulic fracturing site to prepare a proppant mixture for subsequent delivery to a wellbore at the hydraulic fracturing site. The system 10 includes two types of proppant storage container 12 and 14 each storing a different type of proppant for use in forming the proppant mixture; a feed conveyor 16 for receiving and transferring the proppants away from their respective storage containers 12 and 14; and a blender 18 (schematically shown) for receiving the proppants from the feed conveyor 16 and for mixing the proppants to form the proppant mixture.

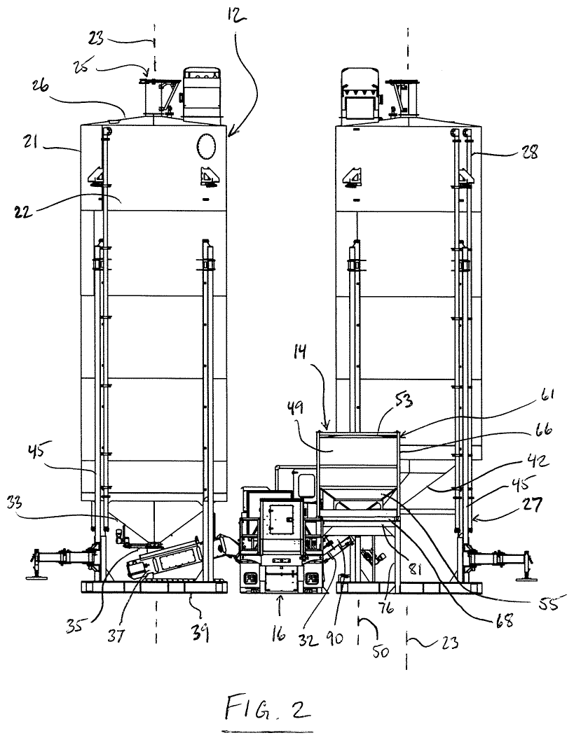

A first type of proppant storage container for storing a primary type of proppant for use in a majority proportion in forming the proppant mixture is indicated at 12 and comprises a silo 21 having a circular cylindrical peripheral wall 22 encompassing an upstanding axis 23 of the silo (the latter shown in FIG. 2). The silo 21 defines a fill opening 25 for receiving the primary type of proppant in the silo. Typically, this fill opening 25 is defined at a top 26 of the silo and opens upwardly. Additionally to the fill opening 25 which can be used to fill the silo with proppant, the first type of storage container includes a pneumatic filling system 27 comprising a plurality of ducts 28 extending upwardly along a height of the silo 21 at angularly spaced positions relative to the silo axis 23 externally of the silo. The ducts 28 are communicated with an interior of the silo at a plurality of spaced locations across the height of the silo. The pneumatic filling system 27 thus is arranged to pneumatically convey particulate material substantially from ground level upon receipt from a transport truck and upwardly to the silo. The fill opening 25 and the pneumatic filling system 27 provide alternative manners of filling the silo with proppant.

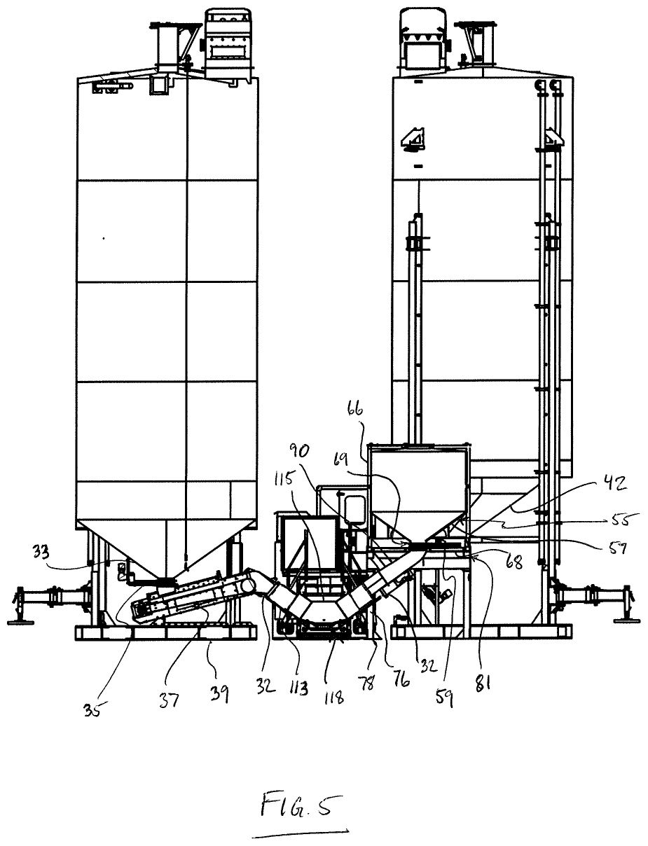

The silo 21 has a bottom discharge 31 at a bottom of the silo for releasing from the interior of the silo the primary type of proppant that is received in the silo. The bottom silo discharge 31 is arranged to convey the primary type of proppant towards one side of the silo so as to be discharged to this one side thereof out of a terminus 32 of the bottom discharge of the first type of proppant storage container from which the primary type of proppant is arranged to exit the first type of proppant storage container 12 for subsequent receipt by the feed conveyor 16. As more clearly shown in FIGS. 2 and 5, the bottom silo discharge may be in the form of a centrally downwardly tapering hopper bottom 33 with a openable gate 35 selectively obstructing a downwardly opening discharge aperture so that the material is discharged downwardly by gravity at a location within a periphery of the silo and onto a feeder conveyor 37 which subsequently transfers the material to one side of a base 39 on which the silo is carried, and further to the feed conveyor 16. Alternatively, the bottom silo discharge may be in the form of a side-tapering hopper bottom 42 which conveys the proppant to one side of the silo by gravity.

The silo 21 is sized larger in height from the bottom discharge 31 to the top 26 of the silo than in diameter of the cylindrical peripheral silo wall 22. Typically, the height of the silo is in the order of about 40 to 50 feet.

The first type of storage container 12 further includes a planar base 39 in the form of a pad which is oriented substantially perpendicularly to the upstanding silo axis 23 and is spaced below the bottom discharge 31 of the silo for resting on a ground surface. Thus the silo 21 is supported generally above the base 39 and there is provided a clearance gap therebetween so that the proppant in the silo can be conveyed to the periphery of the storage container 12, wherefrom the material is available to be received by another piece of equipment for further handling or processing.

Furthermore, the first type of storage container 12 includes a plurality of upstanding legs 45 interconnecting the silo 21 and the base 39. The legs 45 stand upright from the base 39 and extend upwardly along the height of the cylindrical peripheral wall 22 where they connect to the silo.

A second type of storage container for storing a secondary type of proppant for use in a lesser quantity as compared to the primary type of proppant in forming the proppant mixture is indicated at 14 and comprises a rectanguloid container 48 having a rectangular peripheral wall 49 encompassing an upstanding axis 50 of the rectanguloid container. The rectanguloid container 48 defines an upwardly-opening top fill opening 52 at a top 53 of the rectanguloid container for receiving the secondary type of proppant therein. Further, the rectanguloid container has a bottom discharge 55 at a bottom of the rectanguloid container for releasing the second type of proppant received in the rectanguloid container. As more clearly shown in FIG. 5, the bottom discharge 55 is in the form of a centrally downwardly tapering hopper bottom 57 and defines a centrally located downwardly opening aperture which is selectively obstructed by an openable gate 59 such that the proppant is released in a downward direction from the container 48 to a location disposed within a periphery thereof defined by the rectangular peripheral wall 49.

Referring to FIGS. 1-5, the second type of storage container 14 further includes a support frame 61 connected to the rectanguloid container 48 and defining an annular base 63 which is adapted for resting on the ground surface. More specifically, the support frame 61 comprises a plurality of upstanding frame members 66, one at each corner of the rectanguloid container 48, connected to the peripheral wall 49 and interconnected at their bottoms by a series of cross members 68 each one extending between a pair of adjacent upstanding frame members 66 so as to form a ring substantially at the periphery of the rectanguloid container 48. The cross-members 68 lie substantially in a common horizontal plane at the bottoms of the frame upstanding members 66. As such, the annular base 63 encompasses the bottom discharge 55 and is disposed at substantially a common height with a terminus 69 of the bottom discharge from which the second type of proppant is arranged to exit the rectanguloid container 48, such that when the annular base 63 is rested on the ground surface, the terminus 69 of the bottom discharge 55 is basically located at the ground surface. Additionally, a pair of spaced substantially parallel and substantially horizontally extending members 70 in the form of inverted channels or tubular beams with at least one open end are mounted above the annular base 63, one on either side of the terminus 69 of the discharge, for receiving forks of a forklift for moving the second type of storage container 14 at the hydraulic fracturing site.

In comparison of the two types of proppant storage container, the rectanguloid container 48 is sized smaller in volume than the silo 21 such that the amount of proppant storable in the second type of storage container 14 is less than a capacity of the first type 12, and overall the second type of proppant storage container 14 is sized shorter in height, as measured from the base 39, 63 which is adapted for resting on the ground surface to the top 26, 53, than the first type of proppant storage container 12. Generally speaking, the rectanguloid container-style of container is about one-fifth to one-half the height of the silo-style of storage container.

The second type of storage container 14 is more suitably sized in volumetric capacity for storing the secondary types of proppant which are generally specialty proppants used in forming the proppant mixture delivered to the wellbore. Based on the amount of specialty proppant typically used in a fracking operation, the first type of storage container 12 is generally too large for its entire volumetric capacity to be used to store a specialty proppant and thus if the silo 21 were used in this manner, the silo capacity would not be utilized to its maximum capacity.

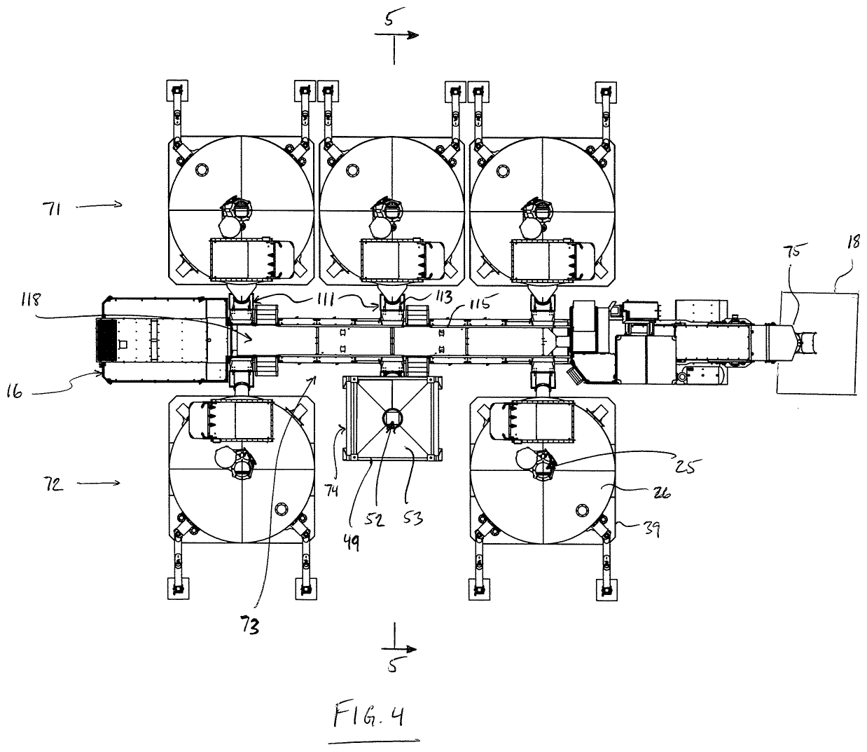

Thus, the delivery system 10 provides an arrangement for dispensing proppant at a hydraulic fracturing site which combines two types of delivery systems each based on a different type of storage container 12, 14 so as to maximize volumetric capacity of each container type. A plurality of the first type of proppant storage container 12 for containing the most commonly used proppant and at least one of the second type of proppant storage container 14 each for containing a secondary proppant used in lesser quantity than the primary proppant are arranged in an array similar to that used in a silo-only proppant delivery system in which there are formed a pair of substantially parallel rows 71, 72 as more clearly shown in FIG. 4. The rows 71, 72 of the containers are spaced apart at a suitable distance to receive therebetween a conveying apparatus arranged to transfer material in a direction substantially parallel to the rows, as will be described in further detail shortly. Each row 71, 72 comprises a series of adjacent storage containers located one next to the other of that row. The containers in each row are arranged in a manner so as to be able to discharge their contents in a direction which is transverse to the row to a common central area 73 of the array which separates the rows, where the aforementioned conveying apparatus can be received. Typically, each row is formed by three or four storage containers.

In order to discharge material from the second type of proppant storage container 14 to the conveying apparatus to be located between the rows and therefore to one side of the storage container 14, there is provided a support stand 74 which elevates the storage container of the second type 14 relative to the ground surface such that the terminus 69 of the bottom discharge 55 is held at a spaced height above the ground surface so as to be suitably accessible, as otherwise (when the support frame 61 is rested on the ground surface) the bottom discharge's terminus 69 is basically located at the ground surface, and so that the proppant discharged therefrom can be properly guided to the receiving conveying apparatus of the proppant delivery system for subsequent delivery of the proppants to the blender.

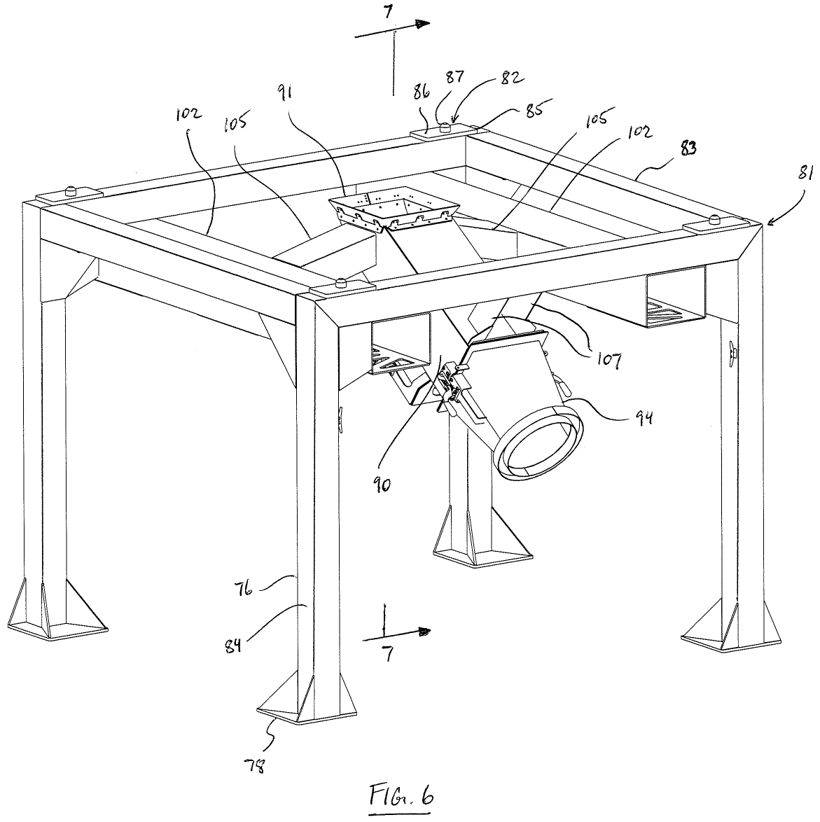

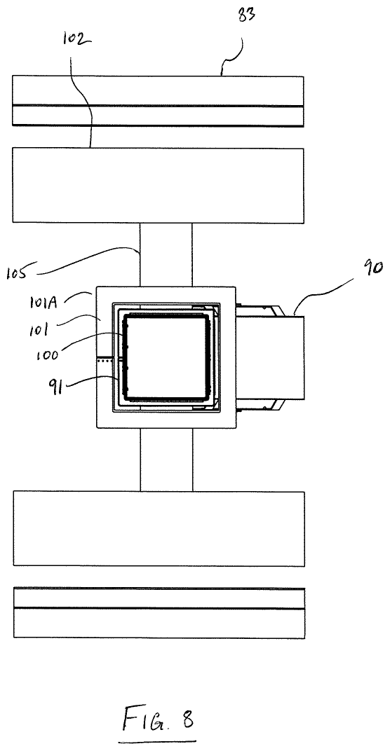

Referring particularly to FIGS. 6-8, the support stand 74 comprises a plurality of upstanding legs 76 having bottoms 78 which are adapted for resting on the ground surface, and a platform 81 connected to the legs 76 at a spaced height above the leg bottoms 78, and generally connected to tops of the legs so as to be at a top of the stand. The platform 81 defines a substantially horizontal support surface 82 for connecting to the support frame 61 of the storage container of the second type 14. The platform 81 is substantially formed by a plurality of cross members 83 collectively arranged in an annulus sized and shaped to substantially correspond to the annular base 63 of the storage container 14, and each cross member 83 interconnects a pair of the legs 76.

The legs 76 are located at spaced positions on a periphery of the platform 81 and depend vertically downwardly therefrom such that the platform and legs are vertically in-line with another, and substantially with the support frame 61 which itself is box-shaped. The platform 81 is sized in a fore-and-aft direction so as to be substantially equal to a fore-and-aft dimension of the second type of storage container 14 measured in a longitudinal direction of the forklift pockets 70, but is sized in a side-to-side direction slightly larger than a side-to-side dimension of the second type of storage container 14 measured substantially perpendicularly transversely to the longitudinal direction of the forklift pocket 70. Therefore, the supporting base underlying the storage container 14 that is defined by the support stand 74 is slightly larger than a footprint of the storage container 14 so as to provide increased stability while remaining of a suitable overall size so as to be movable into and out of position between a pair of the type of storage containers 12 one located on either side of the stand 74 supporting the storage container 14.

The bottoms 78 of the legs 76 are enlarged relative to bodies 84 of the legs so as resist sinking into the ground surface, but the bottoms on the legs 76 disposed on the side of the stand 74 to be located adjacent the conveying apparatus are flush with the bodies 84 on the conveying apparatus-side of the stand.

Plates 85 mounted on tops of the cross members 83 have upper plate surfaces 86 lying in a common plane so as to define the support surface 82 of the platform. The support surface 82 engages a bottom of the annular base 63 of the storage container support frame 61.

There are provided on the platform 81 a plurality of upstanding guide pins 87 mounted to the plates 84 which project upwardly above the support surface 82 defined by the platform 81 and are located thereon at spaced locations for mating with the support frame 61 of the second type of proppant storage container 14 so as to align the bottom discharge 55 thereof relative to the support stand 74. That is, the support frame 61 of the storage container of the second type 14 defines at its bottom a plurality of downwardly-opening apertures (not visible in the figures) at predetermined locations thereon which can receive the guide pins 87 on the stand 74 so as to define a prescribed relative position of the container when received on the support stand. Generally speaking, the platform 81 is connected to the support frame 61 so as to be held in fixed relation thereto when the storage container 14 is rested on the support stand 74. This may be facilitated at least in part by the guide pins 87 which resist relative horizontal movement between these components as weight of the proppant storage container 14 acts to anchor the storage container 14 to the stand 74 vertically.

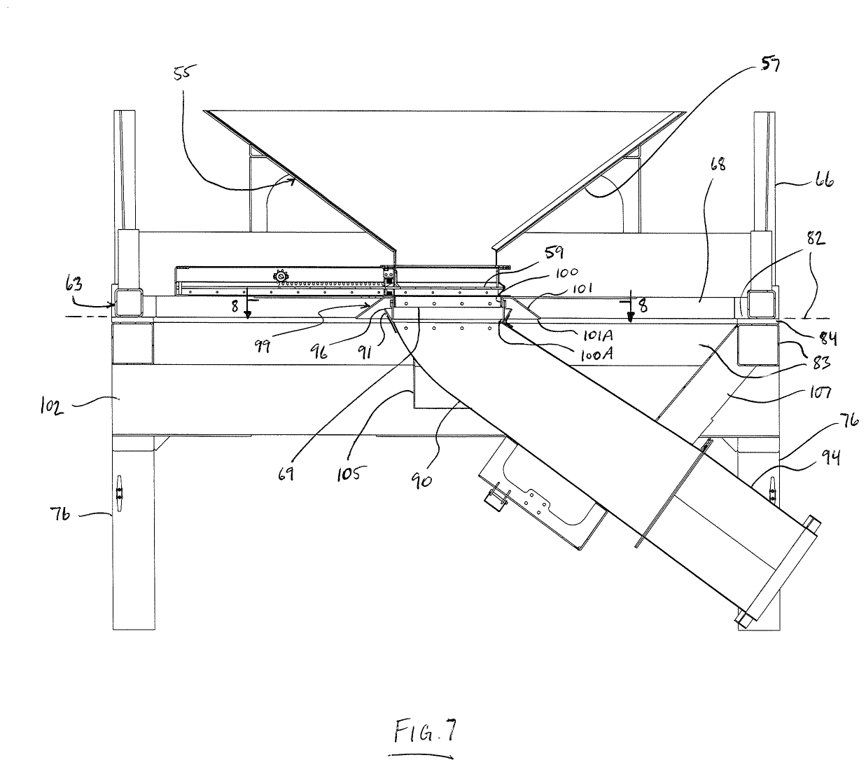

The support stand 74 further includes a chute 90 mounted in fixed location to the platform 81. The chute includes an intake 91 which is communicable with the terminus 69 of the bottom discharge of the second type of storage container so as to receive from the rectanguloid container 48 the second proppant stored therein, and from the chute intake 91 the chute extends downwardly and horizontally to a discharge 94 of the chute 90 so as to guide the proppant towards a side of the support stand 74. The discharge 94 of the chute is located at the periphery of the stand so that the proppant is conveyed thereby to the side of the stand 74. The chute intake 91 is located generally centrally of the platform 81 so as to register relative to a substantially horizontal plane with the centrally located bottom discharge terminus 69, and as shown in FIG. 7 the intake 91 extends upwardly above the support surface 82 such that a top 96 of the intake 91 is spaced thereabove so as to bridge at least a portion of a clearance gap between a bottom of the annular base 63 and the terminus 69 of the bottom discharge 55.

The chute intake 91 is flared towards the top 96 and is oversized at the top 96 relative to the terminus 69 of the bottom discharge 55 such that the intake 91 can substantially receive therein an annular member 99 which is attached to the terminus 69 of the bottom discharge 55 and depends downwardly beyond the terminus 69 of the bottom discharge for substantially sealing with the intake 91 of the chute when disposed in operative communication therewith. The annular member 99 comprises a resilient annular inner portion 100 which extends vertically downwardly from the terminus 69 so as to define a downward extension thereof and an annular outer portion 101 which extends downwardly from the bottom discharge 55 at an outwardly spaced location from the terminus 69 of the bottom discharge so as to surround a periphery of the intake 91 of the chute for resisting entrance of moisture at the intake 91. When the second type of proppant container 14 is supported on the stand 74, a free bottom edge 100A of the inner portion 100 is disposed in substantially sealing contact with an interior surface of the chute intake 91 at as spaced location below the top 96 of the intake such that the seal is formed within the intake 91 and a path for the proppant from the bottom discharge 55 to the chute 90 is substantially enclosed circumferentially relative to a flow direction of the proppant along this path. The outer portion 101 of the annular member is disposed at an external spaced location relative to the intake 91 of the chute so as not to be in contact therewith, and is inclined downwardly and radially outwardly away from the terminus 69 of the bottom discharge so as to act to deflect precipitation away from the intake 91. A bottom edge 101A of the outer portion 101 is located below the top 96 of the intake and is radially spaced from an exterior surface of the intake so as not to be in contact therewith nor with the intake top 96. Thus simply by lowering the storage container 14 onto the support stand 74 the seal may be formed between the bottom discharge 55 and the chute intake 91.

The chute 90 is inclined so as to extend along a linear path downwardly and horizontally from the intake 91 of the chute to the discharge 94 of the chute at an angle between 30 and 40 degrees below a horizontal plane so that the proppant guided therethrough by gravity and dispensed by gravity to the receiving conveying apparatus is suitably discharged.

The chute 90 is supported in fixed relation to the platform 81 by a pair of spaced substantially parallel and substantially horizontally extending beams 102 connected to the platform 81 such that the chute is disposed between the beams 102. The beams 102 span between a diametrically opposite pair of the platform cross members 83 and are connected to undersides thereof. The beams 102 are generally tubular in shape and open at one or more ends thereof so as to be suited for receiving forks of a forklift for moving the support stand 74 at the hydraulic fracturing site. Thus the beams 102 act as forklift pockets. The chute 90 extends from its intake 91 to its discharge 94 substantially parallel to the beams 102 so as to be disposed at a location relative to the forklift pockets where the chute 90 is less likely to be inadvertently struck by forks of a forklift.

Interconnecting each beam 102 and the chute 90 is an inclined beam member 105 extending upwardly and horizontally from the beam to the chute which has its intake 91 held above the beam 102. These inclined beam members 105 form with the chute 90 a generally arch-shaped assembly bridging between the forklift pocket beams 102. A pair of parallel supplementary support members 107 depends at an incline from one of the platform cross-members 83 to a top of the chute nearer its discharge 94 so as to support the chute thereat, such that the chute discharge 94 is suspended from the platform 81. Thus there are no support members below the chute so as to leave an area between the stand legs 76 substantially unobstructed for operators to move around.

Returning now to the arrangement of the storage container 14 on the support stand 74 within the array, between the rows 71, 72 of the array is located the feed conveyor 16 which is operable to receive the proppant from the storage containers 12, 14 and is arranged in a manner so as to transfer particulate material in the form of the proppants in a direction which is substantially parallel to the rows 71, 72 to a discharge 75 of the feed conveyor. In this configuration, the array of otherwise adjacent rows is interrupted by the feed conveyor 16 disposed intermediate the rows 71, 72. Each storage container and more generally each row of storage containers is located to one side of the feed conveyor.

Referring to FIGS. 2 and 4, in order to minimize height of the support stand 74 (for example, so as to maintain a lowest possible center of gravity of the storage container 14) while providing a prescribed angle of inclination of the chute 90 for suitable discharge of proppant by gravity, the second type of proppant storage container 14 carried on the support stand 74 is located more closely to the feed conveyor 16 in a transverse direction to the rows than the first type of proppant storage container 12. Thus, where at least one of the second type of storage container 14 is located in a common row with at least one of the first type of proppant storage container 12, a center of the second type of proppant storage container 14 carried on the support stand 74 and arranged in the array is offset from a center of the respective one of the first type of proppant storage container 12 in a direction towards the feed conveyor so as to be located more closely thereto.

Referring to FIG. 5, the terminus 69 of the bottom discharge of the second type of proppant storage container 14 disposed on the support stand 74 is raised relative to the terminus 32 of the bottom discharge of the first type of storage container 12. This may enable suitable discharge of the proppant from the second type of storage container when achieved by gravity through the chute 90.

Referring to FIGS. 4 and 5, the feed conveyor 16 generally comprises a plurality of intakes 111 on sides of the feed conveyor 16 so as to accept particulate material transferred in a transverse substantially non-vertical direction to the conveying direction thereof. Each intake 111 is disposed in operative communication with the discharge of the respective one of the storage containers 12 or 14 in the array such that the feed conveyor 16 is operatively coupled to receive the first and second types of proppant stored in the first and second types of proppant storage containers 12, 14. In the illustrated arrangement, the operative coupling is achieved by a bridging conduit 113 which extends from the intake 111 defined by a housing 115 of the feed conveyor 16 to the storage container discharge. The feed conveyor 16 includes a conveying member 118 supported within the housing 115 in a manner so as to be operable to transfer the received proppant from the intakes 111 in a longitudinal direction along the feed conveyor towards a common conveyor discharge 75 which releases the proppant to a discharge location located outside a footprint of the array of storage containers.

The blender 18 is operatively coupled to the discharge 75 of the feed conveyor 16 so as to receive the particulate material in the form of the proppants therefrom for mixing to form the proppant mixture. The blender 18 is in the form of a bin with an open top which is disposed at a location coinciding with the discharge 75 of the feed conveyor so as to be disposed in operative communication therewith to receive the proppants.

A hydraulic fracturing operation is designed to be portable so that equipment can be readily moved from one site to the next so as to be reused.

As such, in use of the proppant delivery system 10, all of the storage containers 12 and 14 to be used in the fracking operation are initially transported to the site, as well as the feed conveyor 16 which is mounted on a towable frame and the blender 18 which typically also is mounted on a towable frame. The first, silo type of storage container 12 is transported to the fracking site in an emptied state on a trailer towed by a semi-tractor. During transport the first type of storage container 12 is supported in a substantially horizontal orientation where its axis 23 is substantially horizontal, but upon arrival at or delivery to the fracking site where the storage container of the first type 12 will be used to temporarily store proppant, the storage container 12 is raised by operation of the specially designed trailer from its horizontal transport condition to an upstanding condition in which the first type of storage container 12 is rested on its base 39 with which it was transported. When the storage container 12 is being disposed in its upstanding condition it is arranged at the desired location on the fracking site for placement upon raising of the storage container 12 as it is not readily portable when disposed in the upstanding condition. Once disposed in the upstanding operating condition, transport trucks carrying proppant for storage in the first type of storage container 12 are dispatched to the fracking site and the proppant is transferred therefrom to the storage container 12 locally at the fracking site.

In contrast, the second type of storage container 14 is filled with material at a remote location to the fracking site and is loaded typically onto a flat deck trailer towed by a semi-tractor for transport to the fracking site. At the fracking site, the storage container of the second type 14 is handled by a forklift which lifts the storage container and moves to the desired location within the site.

Prior to arranging the storage container of the second type 14 in the array, the support stand 74 which is distinct from the storage container is arranged in the array, basically at the location where the storage container 14 is to be disposed, so as to locate the support stand to one side of the feed conveyor 16 in accordance with the array. The second type of storage container 14 is then located on the support stand 74, so as to be supported to one side of the feed conveyor at a spaced height above the ground surface so that the bottom discharge 55 thereof is transversely spaced from the feed conveyor 16 and is spaced above the ground surface.

With the second type of storage container 14 supported on the support stand 74 and arranged in the array, proppant from the storage container 14 is then transferred to the feed conveyor 16 for subsequent delivery to the blender 18.

Once the storage container 14 is emptied, it is transported back to the remote filling site and replaced in the array by another like container which is pre-filled. If secondary types of proppants are no longer needed, then the used storage container 14 can be replaced in the array by a storage container of the first type 12.

In this manner the secondary types of proppant which are stored in the second type of proppant storage container 14 can be discharged to the feed conveyor 16 which cannot otherwise receive the contents thereof as the feed conveyor is not arranged to support the storage container 14 vertically thereabove. This provides the advantage of using the feed conveyor 16 which typically is arranged with measurement devices to monitor quantities of the secondary types of proppant which are dispensed for use in the proppant mixture.

As described herein the present invention relates generally to adapting a proppant storage container of the type comprising a rectanguloid container with a bottom discharge and a support frame forming an annular base for resting on a ground surface, where the annular base encompasses the bottom discharge and is disposed substantially at common height therewith, for use in proppant delivery system typically suited for a proppant storage container of the type comprising a silo mounted in an elevated condition above a planar base adapted for resting on the ground surface by providing a support stand to raise the rectanguloid-type container above the ground surface, so that the bottom discharge of the container can be operatively communicated with a feed conveyor located to one side thereof so as to transfer stored proppant thereto. Preferably the support stand is distinct from the rectanguloid-type container so that the existing functionality thereof remains unchanged.

The scope of the claims should not be limited by the preferred embodiments set forth in the examples but should be given the broadest interpretation consistent with the specification as a whole.

1. A proppant delivery system for use at a hydraulic fracturing site to prepare a proppant mixture for subsequent delivery to a wellbore at the hydraulic fracturing site, comprising:
a plurality of a first type of proppant storage container for storing a primary type of proppant for use in forming the proppant mixture;
the first type of proppant storage container comprising:
a silo having a cylindrical peripheral wall encompassing an upstanding axis of the silo;
the silo defining a fill opening for receiving the primary type of proppant in the silo;
the silo having a bottom discharge at a bottom of the silo for releasing the primary type of proppant received in the silo;
the bottom discharge being arranged to convey the primary type of proppant towards one side of the silo so as to be discharged to said one side;
the silo being sized larger in height from the bottom discharge to a top of the silo than in diameter of the cylindrical peripheral wall;
a planar base oriented substantially perpendicularly to the upstanding axis of the container and spaced below the bottom discharge of the silo for resting on a ground surface; and
a plurality of upstanding legs interconnecting the silo and the base;
at least one of a second type of proppant storage container for storing a secondary type of proppant for use in a lesser quantity as compared to the primary type of proppant in forming the proppant mixture;
the second type of proppant storage container comprising:
a rectanguloid container having a rectangular peripheral wall encompassing an upstanding axis of the rectanguloid container;
the rectanguloid container being sized smaller in volume than the silo;
the rectanguloid container defining a top fill opening at a top of the rectanguloid container for receiving the secondary type of proppant therein;
the rectanguloid container having a bottom discharge at a bottom of the rectanguloid container for releasing the second type of proppant received in the rectanguloid container;
a support frame connected to the rectanguloid container and defining an annular base which is adapted for resting on the ground surface;
the annular base encompassing the bottom discharge of the rectanguloid container and being disposed at substantially a common height with a terminus of the bottom discharge from which the second type of proppant is arranged to exit the rectanguloid container;
the second type of proppant storage container being sized shorter in height than the first type of proppant storage container;
the plurality of the first type of proppant storage container and the at least one of the second type of proppant storage container being arranged in an array comprising a pair of substantially parallel rows;
a feed conveyor disposed between the rows of the array and arranged to transfer particulate material in a direction which is substantially parallel to the rows to a discharge of the feed conveyor;
the feed conveyor being operatively coupled to receive the first and second types of proppant stored in the first and second types of proppant storage containers;
a blender operatively coupled to the discharge of the feed conveyor so as to receive the particulate material therefrom for mixing to form the proppant mixture;
the at least one of the second type of proppant storage container that is arranged in the array being located on a support stand, the support stand defining at a top thereof a platform which is connected to the support frame of the at least one of the second type of proppant storage container and further including a plurality of upstanding legs depending downwardly from the platform to bottoms of the legs which are adapted for resting on the ground surface such that the terminus of the bottom discharge of the at least one of the second type of proppant storage container is held at a spaced height above the ground surface so that the second type of proppant can be discharged to the feed conveyor.

2. The proppant delivery system of claim 1 wherein the at least one of the second type of proppant storage container carried on the support stand and arranged in the array is located more closely to the feed conveyor in a transverse direction to the rows than a respective one of the first type of proppant storage container.

3. The proppant delivery system of claim 1 wherein the terminus of the bottom discharge of the second type of proppant storage container is raised relative to a terminus of the bottom discharge of the first type of proppant storage container from which the primary type of proppant is arranged to exit the first type of proppant storage container for subsequent receipt by the feed conveyor.

4. The proppant delivery system of claim 1 wherein the support stand further includes a chute mounted in fixed location to the platform for interconnecting the terminus of the bottom discharge of the at least one of the second type of proppant storage container and an intake of the feed conveyor.

5. The proppant delivery system of claim 4 wherein the intake of the chute is raised above a substantially horizontal support surface defined by the platform for engaging a bottom of the annular base of the at least one of the second type of proppant storage container.

6. The proppant delivery system of claim 4 wherein the chute is inclined downwardly and horizontally from an intake of the chute, which is communicated with the terminus of the bottom discharge of the at least one of the second type of proppant storage container, to a discharge of the chute at an angle between 30 and 40 degrees below a horizontal plane.

7. The proppant delivery system of claim 4 wherein the at least one of the second type of proppant storage container includes an annular member attached to the bottom discharge and depending downwardly beyond the terminus of the bottom discharge for substantially sealing with an intake of the chute which is in communication with the terminus of the bottom discharge.

8. The proppant delivery system of claim 7 wherein the intake of the chute is oversized relative to the terminus of the bottom discharge so as to receive substantially therein an annular inner portion of the annular member which defines a downward extension of the terminus of the bottom discharge.

9. The proppant delivery system of claim 4 wherein the chute is supported by a pair of spaced substantially parallel and substantially horizontally extending beams connected to the platform such that the chute is disposed between the beams, the beams being generally tubular in shape and open at one or more ends thereof so as to be suited for receiving forks of a forklift for moving the support stand at the hydraulic fracturing site.

10. A support stand for a storage container which is used to store a hydraulic fracturing proppant, the storage container having:
a rectanguloid container having a rectangular peripheral wall encompassing an upstanding axis of the rectanguloid container;
the rectanguloid container defining a top fill opening at a top of the rectanguloid container for receiving the proppant therein;
the rectanguloid container having a bottom discharge at a bottom of the rectanguloid container for releasing the proppant received in the rectanguloid container;
the bottom discharge defining a downwardly opening aperture such that the proppant is released in a downward direction therefrom;
a support frame connected to the rectanguloid container and defining an annular base which is adapted for resting on a ground surface;
the annular base encompassing the bottom discharge of the rectanguloid container and being disposed at substantially a common height with a terminus of the bottom discharge from which the proppant is arranged to exit the rectanguloid container;
the support stand, in combination with the storage container, comprising:
a plurality of upstanding legs having bottoms which are adapted for resting on the ground surface;
a platform connected to the legs at a spaced height above the bottoms of the legs;
the platform defining a substantially horizontal support surface carrying the support frame of the storage container such that the bottom discharge of the storage container is held at a spaced height above the ground surface; and
a chute mounted in fixed location to the platform having an intake which is in communication with the terminus of the bottom discharge of the storage container, the chute extending downwardly and horizontally from the intake to a discharge of the chute so as to guide the proppant towards a side of the support stand.

11. The support stand of claim 10 wherein the intake of the chute is raised above the support surface defined by the platform.

12. The support stand of claim 10 wherein the chute extends substantially linearly downwardly and horizontally from the intake of the chute to the discharge of the chute at an angle between 30 and 40 degrees below a horizontal plane.

13. The support stand of claim 10 wherein the chute is supported by a pair of spaced substantially parallel and substantially horizontally extending beams connected to the platform such that the chute is disposed between the beams, the beams being generally tubular in shape and open at one or more ends thereof so as to be suited for receiving forks of a forklift for moving the support stand at the hydraulic fracturing site.

14. The support stand of claim 13 wherein the chute extends from the intake of the chute to the discharge thereof substantially parallel to the beams.

15. The support stand of claim 10 wherein the discharge of the chute is suspended from the platform so that an area between the legs of the stand is substantially unobstructed.

16. The support stand of claim 10 further including a plurality of upstanding guide pins projecting upwardly above the platform and located thereon at spaced locations for mating with the support frame of the storage container so as to align the bottom discharge thereof relative to the support stand.

17. The support standing of claim 10 wherein the bottom discharge of the storage container includes an annular member depending downwardly beyond the terminus of the bottom discharge for substantially sealing with the intake of the chute when the intake is in communication with the bottom discharge.

18. The support stand of claim 17 wherein the intake of the chute is oversized relative to the terminus of the bottom discharge so as to receive substantially therein an annular inner portion of the annular member which defines a downward extension of the terminus of the bottom discharge.

19. A method of dispensing proppant at a hydraulic fracturing site to prepare a proppant mixture for subsequent delivery to a wellbore at the hydraulic fracturing site, comprising:
providing a storage container storing a proppant for use in forming the proppant mixture, the storage container comprising:
a rectanguloid container having a rectangular peripheral wall encompassing an upstanding axis of the rectanguloid container;
the rectanguloid container defining a top fill opening at a top of the rectanguloid container for receiving the proppant therein;
the rectanguloid container having a bottom discharge at a bottom of the rectanguloid container for releasing the proppant received in the rectanguloid container;
a support frame connected to the rectanguloid container and defining an annular base which is adapted for resting on a ground surface;
the annular base encompassing the bottom discharge of the rectanguloid container and being disposed at substantially a common height with a terminus of the bottom discharge from which the second type of proppant is arranged to exit the rectanguloid container;
providing a feed conveyor operable to receive the proppant from the storage container and to transfer the proppant in a longitudinal direction along the feed conveyor;
providing a blender operable to receive the proppant from the feed conveyor and to mix the proppant for forming the proppant mixture;
supporting the storage container to one side of the feed conveyor at a spaced height above the ground surface so that the bottom discharge thereof is transversely spaced from the feed conveyor and is spaced above the ground surface; and
transferring the proppant from the storage container to the feed conveyor for subsequent delivery to the blender.

20. The method of claim 19 wherein supporting the storage container comprises:
providing a support stand which is distinct from the storage container for supporting the storage container at the spaced height above the ground surface;
locating the support stand to said one side of the feed conveyor; and
locating the storage container on the support stand.
